(19) United States
(12) Patent Application Publication
(10) Pub. No.: US 2009/0179828 A1
(43) Pub. Date: Jul. 16, 2009

(54) PLASMA DISPLAY DEVICE

(76) Inventor: Masanori Takeuchi, Tokyo (JP)

Correspondence Address: MCDERMOTT WILL & EMERY LLP, 600 13TH STREET, N.W., WASHINGTON, DC, 20005-3096, US

(21) Appl. No.: 12/185,411

(22) Filed: Aug. 4, 2008

(30) Foreign Application Priority Data
Jan. 10, 2008 (JP) 2008-003103

(51) Int. Cl. G09G 3/28

(52) U.S. Cl. 345/60

(57) ABSTRACT

There is provided a plasma display device capable of preventing a moving picture pseudo contour and blurring of a moving picture. The plasma display device includes a plasma display panel in which one display line is formed of a display electrode pair composed of two display electrodes and the display electrode pair on an even display line and the display electrode pair on an odd display line are alternately arranged, the driving circuits supplying voltage to the display electrodes to perform display based on the same display data with one even display line and one odd display line adjacent up and down paired in the plasma display panel, the motion detecting circuit detecting motion in an image based on the image signal and ratio determining circuits determining the ratio of the number of sustain pulses on the even display line to the number of sustain pulses on the odd display line forming the pair.

### CROSS-REFERENCE TO RELATED APPLICATIONS

This application is based upon and claims the benefit of priority from the prior Japanese Patent Application No. 2008-003103, filed on Jan. 10, 2008, the entire contents of which are incorporated herein by reference.

### BACKGROUND OF THE INVENTION

1. Field of the Invention

The present invention relates to a plasma display device.

2. Description of the Related Art

A plasma display device represents gradation using a sub-frame method, so that it produces a moving picture pseudo contour or blurring of a moving picture in a fast motion.

A pamphlet of International Publication WO 2007/004305 describes a plasma display module including a panel section, means processing an interlace signal formed of odd and even frames and a driving section dividing one frame period into a plurality of sub-frames and pairing two adjacent upper and lower cells as a pair in the panel section to perform drive with a signal corresponding to one horizontal scanning line of the interlace signal, wherein the driving section performs drive such that each of the two cells is different in the intensity of light emission in at least one sub-frame out of the plurality of sub-frames.

FIG. 15 is a chart illustrating a method of driving a plasma display module in the pamphlet of International Publication WO 2007/004305. The same data is written with two adjacent upper and lower lines OL and EL paired in each of the odd and even frames. The sub-frame SF has a reset period Tr, an address period Ta and a sustain period Ts. The light emission period of the sustain period Ts corresponds to luminance. The luminance at which all pixels in the line OL are lit is taken as L and the luminance at which all pixels in the line EL are lit is taken as R×L. The light-emission-intensity ratio R is rendered to be any ratio between zero to one to enable the luminance to be improved.

Japanese Patent Application Laid-Open No. 2003-233346 describes a method of driving a dot matrix AC plasma display panel including display electrodes extending adjacently in the same direction and conducting a light emission operation of each display cell and partition walls separating each display cell and forming display lines between all the display electrodes with the interlace method system, wherein data of the interlace signal on one line is displayed simultaneously by the two adjacent lines to shift displaying weight of the two lines between the odd and even fields.

FIG. 16 is a chart illustrating the method of driving the plasma display panel in Japanese Patent Application Laid-Open No. 2003-233346. A pair of the adjacent two lines is paired with a pair of the adjacent two lines shifted by one line between the odd and even fields to allow suppressing reduction in vertical resolution.

### SUMMARY OF THE INVENTION

It is the object of the present invention to provide a plasma display device capable of preventing a moving picture pseudo contour and blurring of a moving picture.

The plasma display device according to the present invention includes: a plasma display panel in which one display line is formed of a display electrode pair composed of two display electrodes and the display electrode pair on the even display line and the display electrode pair on the odd display line are alternately arranged; driving circuits supplying voltage to the display electrodes to perform display based on the same display data with one even display line and one odd display line adjacent up and down paired in the plasma display panel; a motion detecting circuit detecting motion in an image based on the image signal; and ratio determining circuits determining the ratio of the number of sustain pulses on the even display line to the number of sustain pulses on the odd display line forming the pair; wherein the driving circuits supply the display electrodes with sustain pulses equal in number to the sustain pulses the ratio in number between which is determined.

The ratio between the number of sustain pulses is determined according to motion in an image to enable preventing the moving picture pseudo contour and blurring of a moving picture from being produced.

### BRIEF DESCRIPTION OF THE DRAWINGS

FIG. 1 is a block diagram illustrating a constitutional example of a plasma display device according to an embodiment of the present invention;

FIG. 2 is a chart describing the motion of line of sight in a general moving picture;

FIG. 3 is a chart describing the motion of line of sight in a moving picture of the present embodiment;

FIG. 4 is a chart illustrating an example of control of light-emission luminance ratio in a still picture;

FIG. 5 is a chart illustrating an example of control of light-emission luminance ratio in a moving picture;

FIG. 6 is a chart illustrating a constitutional example of one frame according to light-emission luminance ratio in the present embodiment;

FIG. 7 is a chart illustrating an example of process in a motion-amount determining circuit in FIG. 1;

FIG. 8 is a chart illustrating another example of process in the motion-amount determining circuit in FIG. 1;

FIG. 9 is a chart illustrating an example of process in a light-emission-intensity ratio calculating process circuit in FIG. 1;

FIG. 10 is a schematic diagram of a constitutional example of a plasma display device according to the present embodiment;

FIG. 11 is a schematic diagram of a constitutional example of a plasma display panel according to the present embodiment;

FIGS. 12A and 12B are charts describing a method of driving the plasma display panel;

FIG. 13 is a chart illustrating one example of driving waveforms of the plasma display device according to the present embodiment;

FIG. 14 is a chart describing a driving configuration in the present embodiment;

FIG. 15 is a chart illustrating a method of driving a plasma display module in the pamphlet of International Publication WO 2007/004305; and

FIG. 16 is a chart illustrating the method of driving the plasma display panel in Japanese Patent Application Laid-Open No. 2003-233346.

### DETAILED DESCRIPTION OF THE PREFERRED EMBODIMENTS

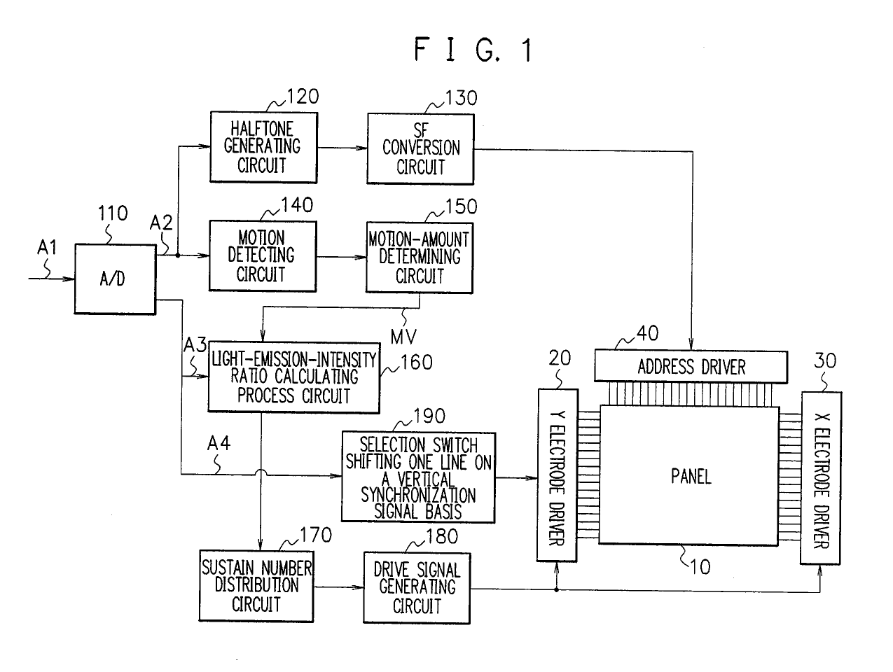

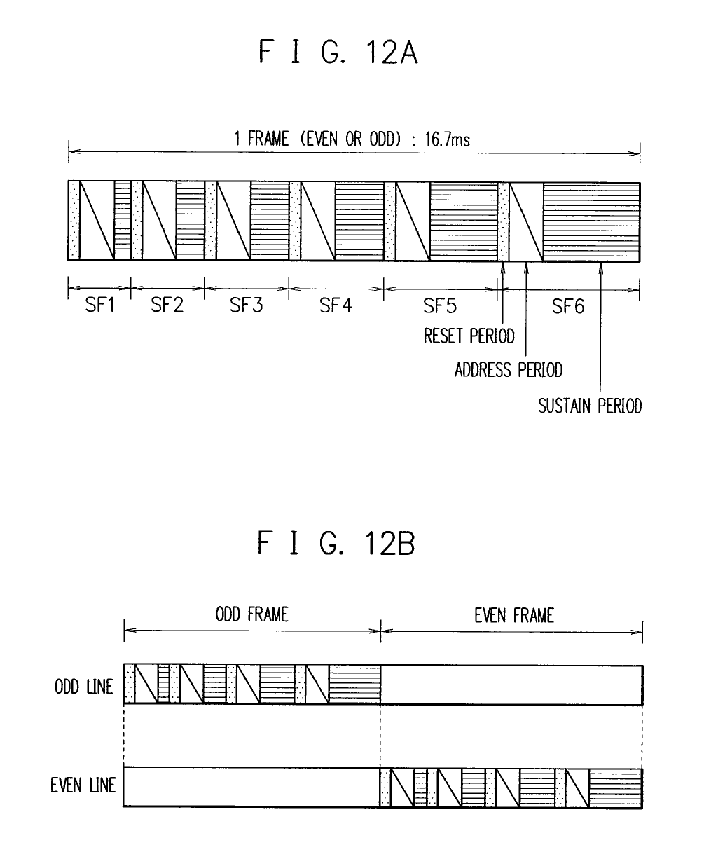

FIG. 1 is a block diagram illustrating a constitutional example of a plasma display device according to an embodiment of the present invention. An A/D converter 110 converts an input analog image signal A1 to a digital image signal A2 and outputs a timing signal A3 and a parity signal A4. A halftone generating circuit 120 generates a halftone by an error diffusion or a dither process to display the input image signal A2 in a lighting pattern with the limited number of bits. For example, the halftone generating circuit 120 error-diffuses a decimal part of the digital image signal A2 with an integral part and the decimal part and outputs an image signal formed of the integral part to a sub-frame (SF) conversion circuit 130. The sub-frame conversion circuit 130 converts the image signal outputted from the halftone generating circuit 120 to the lighting pattern of each sub-frame. The sub-frame is described later with reference to FIG. 12A. A motion detecting circuit 140 detects a moved pixel in the input image signal A2 as motion. The motion-amount determining circuit 150 determines a motion-amount determining signal MV according to the number of moved pixels detected by the motion detecting circuit 140 or the speed of motion of the moved pixels. The greater the number of the moved pixels and the faster the speed of motion of the moved pixels, the greater the motion-amount determining signal MV. For a still picture, the motion-amount determining signal MV is equal to zero. A light-emission-intensity ratio calculating process circuit 160 receives the timing signal A3 as an input and calculates a light-emission-intensity ratio according to the value of the motion-amount determining signal MV. A sustain number distribution circuit 170 distributes the number of sustain pulses to two lines adjacent on a sub-frame basis according to a light-emission-intensity ratio calculated by the light-emission-intensity ratio calculating process circuit 160. A drive signal generating circuit 180 generates a drive signal simultaneously lighting a pair of two adjacent lines based on the number of sustain pulses distributed from the sustain number distribution circuit 170. A selection switch 190 shifts one line on a vertical synchronization signal basis according to the parity signal A4, performs a process shifting one line between the odd and even frames and outputs a processed signal to a Y electrode driver 20. The Y electrode driver 20 applies a voltage to the Y electrode of a plasma display panel 10 according to a drive signal generated by the drive signal generating circuit 180. An X electrode driver 30 applies a voltage to the X electrode of the plasma display panel 10 according to a drive signal generated by the drive signal generating circuit 180. An address driver 40 applies a voltage to the address electrode of the plasma display panel 10 according to the lighting pattern converted by the sub-frame conversion circuit 130. The plasma display panel 10 discharges and emits light according to voltages applied to the address, X and Y electrodes.

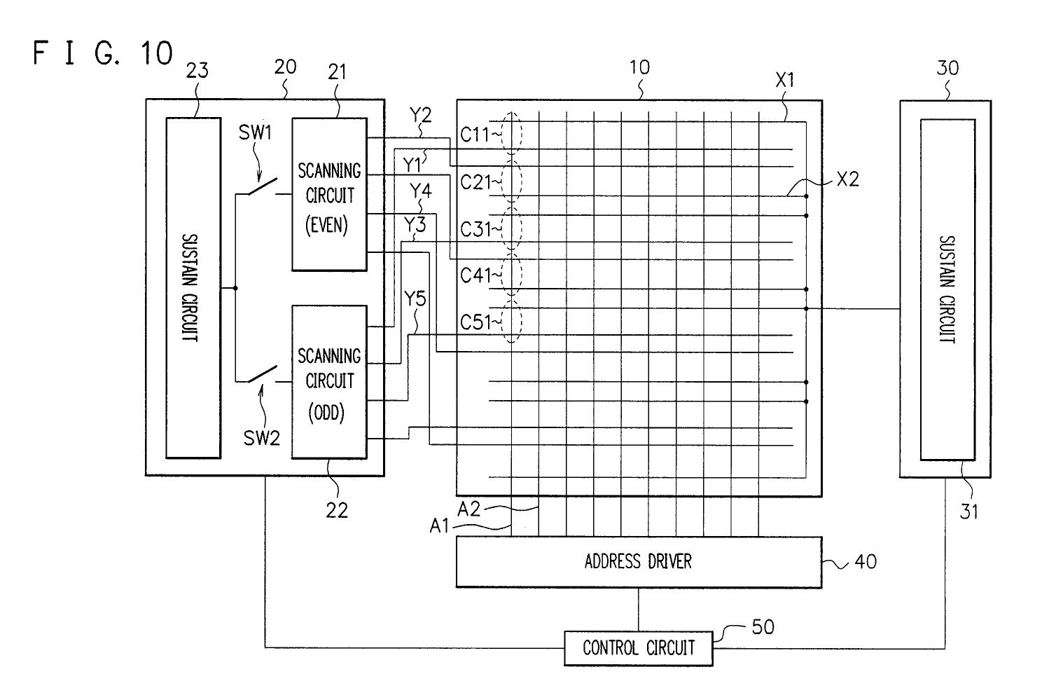

FIG. 10 is a schematic diagram of a constitutional example of the plasma display panel 10, the Y electrode driver 20, the X electrode driver 30 and the address driver 40. A control circuit 50 relates to circuits excluding the plasma display panel 10, the Y electrode driver 20, the X electrode driver 30 and the address driver 40 in FIG. 1.

The Y electrode driver 20 is a circuit driving the Y electrodes (scanning electrode) Y1 and Y2, out of the display electrodes and includes a scanning circuit (even) 21, a scanning circuit (odd) 22 and a sustain circuit 23. Hereinafter, each of the Y electrodes Y1, Y2, . . . or a generic name thereof is referred to as Y electrode Yi, where “i” denotes a subscript.

The scanning circuits 21 and 22 include circuits generating scanning pulses for selecting lines to be displayed by line sequential scanning. The sustain circuit 23 includes a circuit for generating a sustain pulse (or, a sustain discharge pulse) to repeat a sustain discharge. The scanning circuits 21 and 22 and the sustain circuit 23 supply a predetermined voltage to a plurality of the Y electrodes Yi.

The scanning circuit (even) 21 is provided in correspondence to even-numbered Y electrodes Y2, Y4, . . . related to the even display lines out of the display lines and supplies the Y electrodes Y2, Y4, . . . with a drive voltage. The scanning circuit (even) 21 sequentially applies scanning pulses to the Y electrodes Y2, Y4, . . . in the address period and applies sustain pulses from the sustain circuit 23 to the Y electrodes Y2, Y4, . . . in the sustain period at the even frame at which at least even display lines are lit.

Similarly to the above, the scanning circuit (odd) 22 is provided in correspondence to odd-numbered Y electrodes Y1, Y3, Y5, . . . related to the odd display lines and supplies the Y electrodes Y1, Y3, Y5, . . . with a drive voltage. The scanning circuit (odd) 22 sequentially applies scanning pulses to the Y electrodes Y1, Y3, . . . in the address period and applies sustain pulses from the sustain circuit 23 to the Y electrodes Y1, Y3, . . . in the sustain period at the odd frame at which at least odd display lines are lit.

The scanning circuit (even) 21 is connected to the sustain circuit 23 through the switch SW1. The scanning circuit (odd) 22 is connected to the sustain circuit 23 through the switch SW2. The switches SW1 and SW2 are independently turned on or off based on a control signal from the control circuit 50.

It can be independently switched whether or not the output from the sustain circuit 23 is supplied to the scanning circuits 21 and 22 by the switches SW1 and SW2, more specifically, whether or not the output from the sustain circuit 23 is applied to the even-numbered Y electrodes Y2, Y4, . . . by the switch SW1 and the output from the sustain circuit 23 is applied to the odd-numbered Y electrodes Y1, Y3, . . . by the switch SW2. In addition, the switches SW1 and SW2 are turned off to enable independently rendering the even-numbered Y electrodes Y2, Y4, . . . and the odd-numbered Y electrodes Y1, Y3, . . . a high impedance state.

The X electrode driver 30 is a circuit driving the X electrodes (sustain electrode) X1 and X2, . . . out of the display electrodes and includes a sustain circuit 31. Hereinafter, each of the X electrodes X1, X2, . . . or a generic name thereof is referred to as X electrode Xi, where “i” denotes a subscript. The sustain circuit 31 includes a circuit generating a sustain pulse to repeat sustain discharge and supplies a predetermined voltage to the X electrode Xi. One end of the X electrode Xi is connected to the X electrode driver 30.

The address driver 40 includes a circuit selecting columns to be displayed and supplies a plurality of address electrodes A1, A2, . . . with a predetermined voltage. Hereinafter, each of the address electrodes A1, A2, . . . or a generic name thereof is referred to as address electrode Aj, where “j” denotes a subscript.

The control circuit 50 generates a control signal based on display data, a clock signal, a horizontal synchronizing signal and a vertical synchronizing signal inputted from the outside. The control circuit 50 supplies the generated control signal to the Y electrode driver 20, the X electrode driver 30 and the address driver 40 to control the drivers 20, 30 and 40.

In the plasma display panel 10, the Y electrode Yi and the X electrode Xi constituting display electrode pairs form rows extending in parallel in the horizontal direction. The address electrode Aj forms columns extending in the vertical direction. The Y electrode Yi and the X electrode Xi are arranged in the vertical direction, in parallel to each other and in a predetermined arrangement pattern. The address electrode Aj is arranged in the direction substantially perpendicular to the Y electrode Yi and the X electrode Xi. The Y electrode Yi and the address electrode Aj form a two-dimensional matrix with row “i” and column “j.”

In the plasma display panel 10 according to the present embodiment, a display electrode pair formed of two electrodes (a pair of the Y electrode Yi and the X electrode Xi) is arranged on one display line and the display electrodes are not shared between adjacent display lines. That is to say, with “p” as a natural number, a pair of the Y electrode Y(2p−1) and the X electrode X(2p−1) forms odd display lines out of the display lines. A pair of the Y electrode Y(2p) and the X electrode X(2p) forms even display lines. For example, a pair of the Y electrode Y1 and the X electrode X1 forms a first display line and a pair of the Y electrode Y2 and the X electrode X2 forms a second display line.

A cell Cij is formed of the intersection of the Y electrode Yi and the address electrode Aj and the X electrode Xi adjacent and corresponding thereto. The cell Cij corresponds to a red, a green or a blue sub-pixel, for example. The tricolor sub pixels form one pixel. The panel 10 lights a plurality of two-dimensionally arranged pixels to display an image. The scanning circuits 21 and 22 in the Y electrode driver 20 and the address driver 40 determine which cell is lit. The sustain circuit 23 in the Y electrode driver 20 and the sustain circuit 31 in the X electrode driver 30 repetitively discharge to perform a display operation.

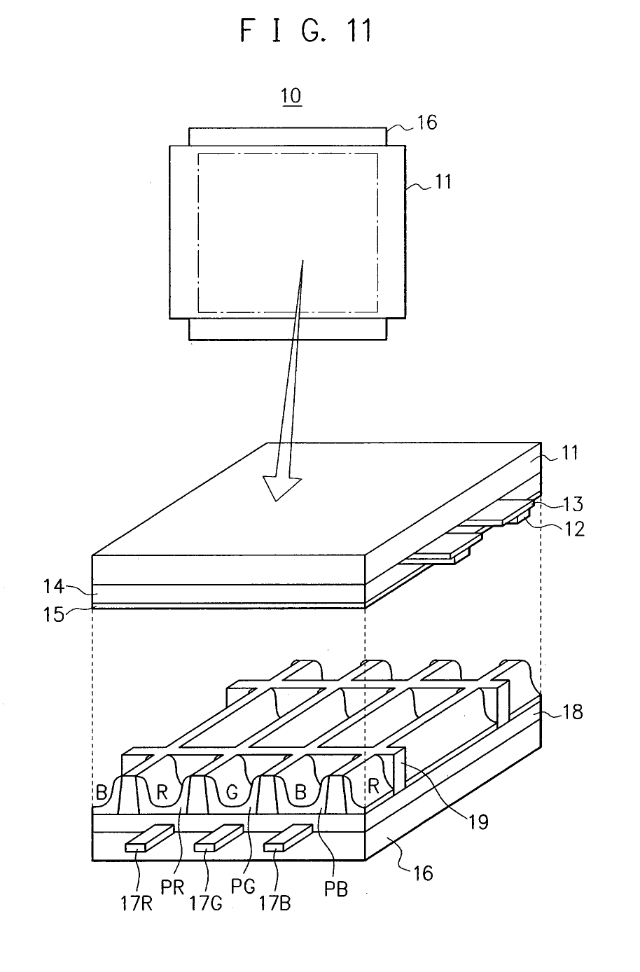

FIG. 11 is an exploded perspective view of a constitutional example of the plasma display panel 10 according to the present embodiment.

On a front glass substrate 11, there is formed the display electrode (also referred to as a sustain electrode) composed of a bus electrode (metal electrode) 12 and a transparent electrode 13. The display electrodes (12 and 13) correspond to the Y electrode Yi and the X electrode Xi illustrated in FIG. 10. On the display electrodes (12 and 13), there is provided a dielectric layer 14. and provided an MgO (magnesium oxide) protective film 15 on the dielectric layer. That is to say, the display electrodes (12 and 13) arranged on the front glass substrate 11 are covered with the dielectric layer 14 and the surface of the dielectric layer 14 is covered with the MgO protective film 15.

On a rear glass substrate 16 arranged opposite to the front glass substrate 11, there are formed address electrodes 17R, 17G and 17B in the direction orthogonal (intersectional) to the display electrodes (12 and 13). The address electrodes 17R, 17G and 17B correspond to the address electrode Aj illustrated in FIG. 10. On the address electrodes 17R, 17G and 17B, there is provided a dielectric layer 18.

Furthermore, on the dielectric layer 18, a closing partition wall (rib) 19 arranged in a lattice shape, that is, partitioning discharge space on a cell basis and phosphor layers PR, PG and PB emitting visible lights of red (R), green (G) and blue (B) for color display. Ultraviolet rays generated by surface discharge between the paired display electrodes (12 and 13) excite the phosphor layers PR, PG and PB to emit each color.

The partition wall 19 is composed of a vertical partition wall (vertical rib) formed in the direction in which the address electrodes 17R, 17G and 17B extend and a horizontal partition wall (horizontal rib) formed in the direction in which the display electrodes (12 and 13) extend. In other words, the plasma display panel 10 according to the present embodiment has a closed partition wall structure.

In the phosphor layers PR, PG and PB, the phosphor layer PR emitting red is formed over the address electrode 17R, the phosphor layer PG emitting green is formed over the address electrode 17G and the phosphor layer PB emitting blue is formed over the address electrode 17B. In other words, the address electrodes 17R, 17G and 17B are so arranged as to correspond to the red, green and blue phosphor layers PR, PG and PB with which the inner face of the partition wall 19 corresponding to cells is coated.

The plasma display panel 10 is formed such that the front glass substrate 11 and the rear glass substrate 16 are sealed so that protective film 15 is brought into contact with the partition wall 19 and a discharge gas such as Ne—Xe is filled in the inside (or, discharge space between the front glass substrate 11 and the rear glass substrate 16).

A method of driving the plasma display panel 10 is described below with reference to FIGS. 12A and 12B. FIG. 12A is a chart describing a method of driving the plasma display panel 10. One frame (an odd frame or an even frame) is formed of a plurality of sub-frames (SF). In FIG. 12A, for a convenience of illustration, one frame includes six sub-frames SF1, SF2, SF3, SF4, SF5 and SF6, however, in general, one frame includes 10 to 12 sub-frames.

Each of the sub-frames SF1 to SF6 is constituted from a reset period, an address period and a sustain period. In the reset period, an electric charge state on the wall over the electrode is initialized. In the address period, the electric charge state on the wall is adjusted based on display data to select cells to be lit. In the sustain period, the cell corresponding to display data is lit (or, the cell selected according to display data is lit by discharge). Selecting which of the sub-frames SF1 to SF6 is lit allows representing gradation.

FIG. 12B is a chart describing one example of an interlace drive of a general plasma display panel. In FIG. 12B, for a convenience of illustration, an odd frame and an even frame are formed of four sub-frames, respectively. In an odd frame, odd display lines are lit and even display lines are not lit. On the other hand, in an even frame, even display lines are lit and odd display lines are not lit.

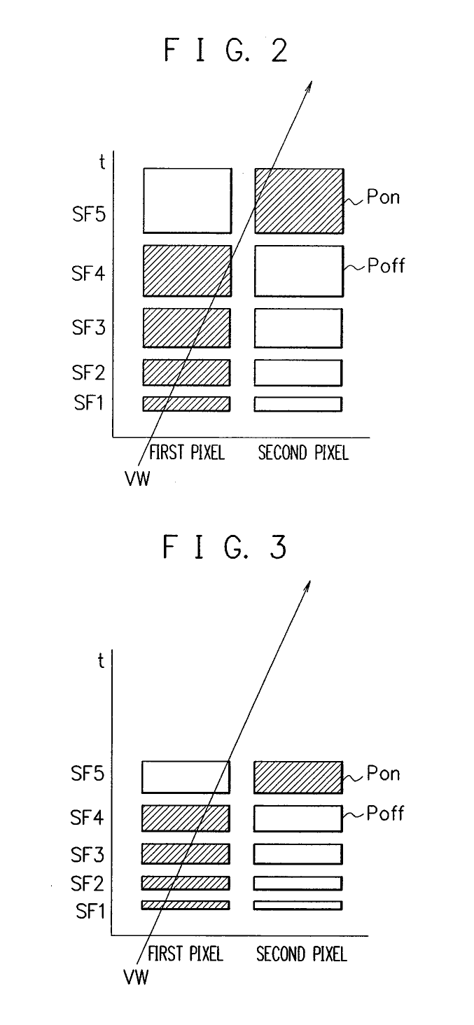

FIG. 2 is a chart describing the motion of line of sight in a general moving picture. An abscissa represents the position of a pixel. An ordinate expresses time t. As time t elapses, there are sequentially displayed a first sub-frame SF1, a second sub-frame SF2, a third sub-frame SF3, a fourth sub-frame SF4 and a fifth sub-frame SF5. A lighting area Pon shows an area where a pixel in each sub-frame is lit by display data “1.” A non-lighting area Poff shows an area where a pixel in each sub-frame is not lit by display data “0.” A first pixel is gradation represented as (SF1, SF2, SF3, SF4, SF5)=(1, 1, 1, 1, 0). A second pixel is gradation represented as (SF1, SF2, SF3, SF4, SF5)=(0, 0, 0, 0, 1). A square time width of each sub-frame corresponds to a light emission period of the sustain period Ts. At this point, when an image moves, line of sight VW crosses sub-frames of each pixel as illustrated in the figure to cause the retina of the human eye to perceive (SF1, SF2, SF3, SF4, SF5)=(1, 1, 1, 1, 1). Viewing a bright gradation causes disturbance in gradation. A problem arises in that a so-called moving picture pseudo contour is produced.

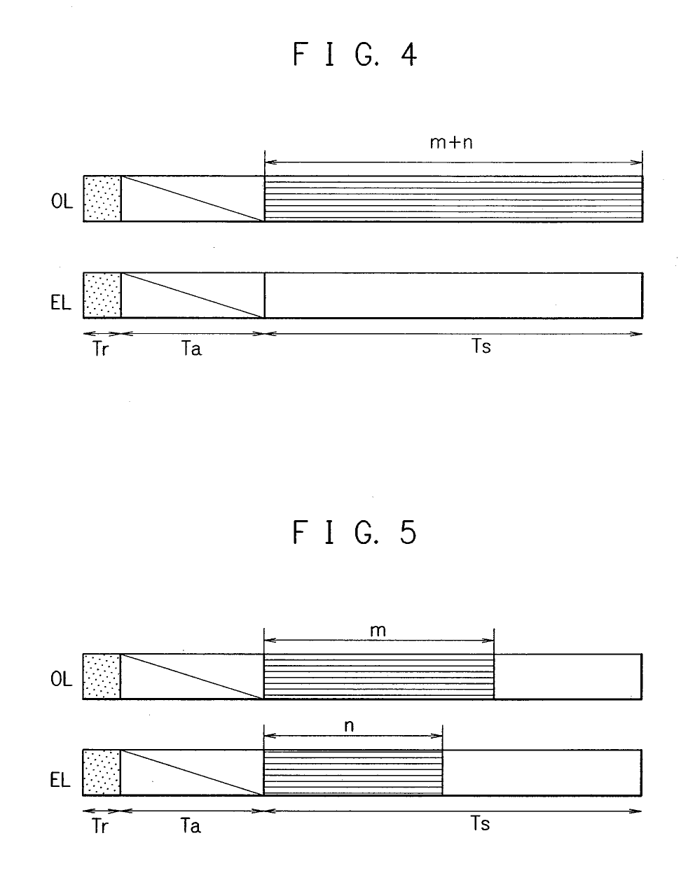

FIG. 3 is a chart describing the motion of line of sight in a moving picture of the present embodiment. The abscissa and the ordinate are the same as in FIG. 2. In this case, since the sustain period Ts of each sub-frame is shortened, when an image moves at the same speed as in FIG. 2, line of sight VW crosses sub-frames of each pixel as illustrated in the figure to cause the retina of the human eye to perceive (SF1, SF2, SF3, SF4, SF5)=(1, 1, 1, 1, 0). Therefore, disturbance in gradation (or, a moving picture pseudo contour) is not caused. A method of shortening the sustain period Ts of each sub-frame is described in detail below with reference to FIGS. 4 to 6.

FIGS. 4 and 5 are charts illustrating examples of control of light-emission-intensity ratio according to the present embodiment. In the following description, a light-emission luminance ratio is taken as an example instead of the light-emission-intensity ratio. One odd line OL and one even line EL adjacent thereto are paired as one pair to perform display based on the image signal of one line. Each line has a reset period Tr, an address period Ta and a sustain period Ts. FIG. 4 shows control in a still picture and FIG. 5 shows control in a moving picture.

As illustrated in FIG. 4, when the light-emission-intensity ratio calculating process circuit 160 determines that a picture is a still picture based on the motion-amount determining signal MV, the circuit 160 sets a light-emission luminance ratio between the even line EL and the odd line OL to zero to one. The sustain number distribution circuit 170 distributes the number of sustain pulses of the odd line OL and the even line EL so that the light-emission luminance ratio between the even line EL and the odd line OL is equal to zero to one. The plasma display panel 10 lights only odd line OL in the sustain period Ts. The number of sustain pulses is equal to m+n in the sustain period Ts of the odd line OL. The number of sustain pulses corresponds to luminance. The above is the same as in an ordinary interlace drive.

As illustrated in FIG. 5, when the light-emission-intensity ratio calculating process circuit 160 determines that a picture is a moving picture based on the motion-amount determining signal MV, the circuit 160 sets a light-emission luminance ratio between the even line EL and the odd line OL to “n” to “m” according to the motion-amount determining signal MV. The sustain number distribution circuit 170 distributes the number of sustain pulses of the odd line OL and the even line EL so that the light-emission luminance ratio is equal to “n” to “m.” The number of sustain pulses of the odd line OL is “m” and that of the even line EL is “n.” In the plasma display panel 10, the odd line OL is lit with the number of sustain pulses of “m” and the even line EL is lit with the number of sustain pulses of “n” in the sustain period Ts. The number of sustain pulses of the odd line OL and the even line EL totals m+n. Both in a still picture or in a moving picture, the number of sustain pulses of a pair of the two of the odd line OL and the even line EL totals m+n and the luminance (gradation) is the same.

As described above, the circuit 160 sets a light-emission luminance ratio between the even line EL and the odd line OL to “n” to “m” according to the motion-amount determining signal MV. In the still picture, n:m is equal to 0:1. The number of sustain pulses of a pair of the odd line OL and the even line EL totals m+n irrespective of the light-emission luminance ratio and the luminance is the same.

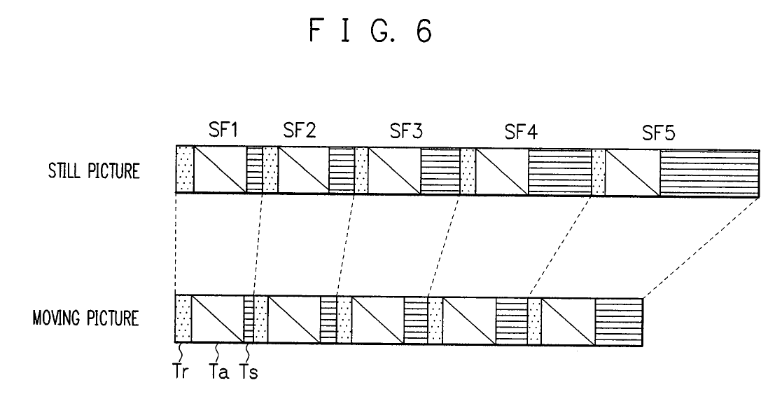

FIG. 6 is a chart illustrating a constitutional example of one frame according to light-emission luminance ratio in the present embodiment. As an example, the sub-frames SF1 to SF5 in one frame are shown. Each sub-frame has a reset period Tr, an address period Ta and a sustain period Ts. The upper half in FIG. 6 shows one frame of the odd line OL of a still picture illustrated in FIG. 4. The lower half in FIG. 6 shows one frame of the odd line OL of a moving picture illustrated in FIG. 5. Since the number of sustain pulses of the odd line OL in a still picture is as many as m+n, the sustain period Ts becomes long and one frame also becomes long. On the other hand, since the number of sustain pulses of the odd line OL in a moving picture is as small as m, the sustain period Ts becomes short and one frame also becomes short. That is to say, the number of sustain pulses of the odd line OL in a moving picture is as small as m, so that spare time is created in the sustain period Ts, therefore, the following sub-frames are sequentially closed up forward. As a result, as illustrated in FIG. 3, the sustain period of each sub-frame is shortened and the moving picture pseudo contour can be avoided.

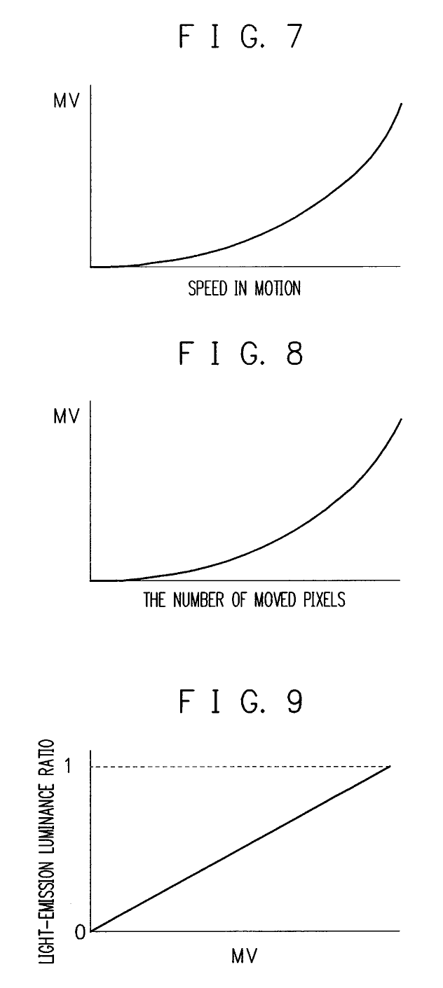

FIG. 7 is a chart illustrating an example of process in the motion-amount determining circuit 150 in FIG. 1. The motion-amount determining circuit 150 outputs the motion-amount determining signal MV according to the speed of motion. The motion-amount determining circuit 150 determines the motion-amount determining signal MV according to the speed of the pixel that is the largest in motion in the pixels whose motion is detected. If there exists a pixel large in motion exceeding the predetermined number of them, the motion-amount determining circuit 150 may determine the motion-amount determining signal MV according to the central value of the speed in consideration of erroneous detection of the motion detecting circuit 140 or the intrusion of noise into an image signal.

FIG. 8 is a chart illustrating another example of process in the motion-amount determining circuit 150 in FIG. 1. The motion-amount determining circuit 150 outputs the motion-amount determining signal MV according to the number of the moved pixels. If the number of the pixels whose motion is detected exceeds a predetermined value, the motion-amount determining circuit 150 determines the motion-amount determining signal MV according to the number.

Incidentally, the motion-amount determining signal MV may be the sum of products in which the motion-amount determining signals illustrated in FIGS. 7 and 8 are multiplied by a predetermined coefficient, respectively.

FIG. 9 is a chart illustrating an example of process in a light-emission-intensity ratio calculating process circuit 160 in FIG. 1. The light-emission-intensity ratio calculating process circuit 160 determines a light-emission-intensity ratio according to the value of the motion-amount determining signal MV. Specifically, the light-emission-intensity ratio calculating process circuit 160 performs control so that the light-emission luminance ratio is increased as the motion-amount determining signal MV is increased. The light-emission luminance ratio varies from zero to one and corresponds to “n” to “m” (=n/m) being the light-emission luminance ratio between the even and odd lines EL, OL in FIGS. 4 and 5. In the case of the still picture in FIG. 4, the light-emission luminance ratio is equal to zero and the ratio of “n” to “m” is equal to zero to one. On the other hand, in the case of the moving picture that is the largest in motion, the light-emission luminance ratio is equal to one and the ratio of “n” to “m” is equal to one to one, in the case of which the sustain period Ts can be made shortest.

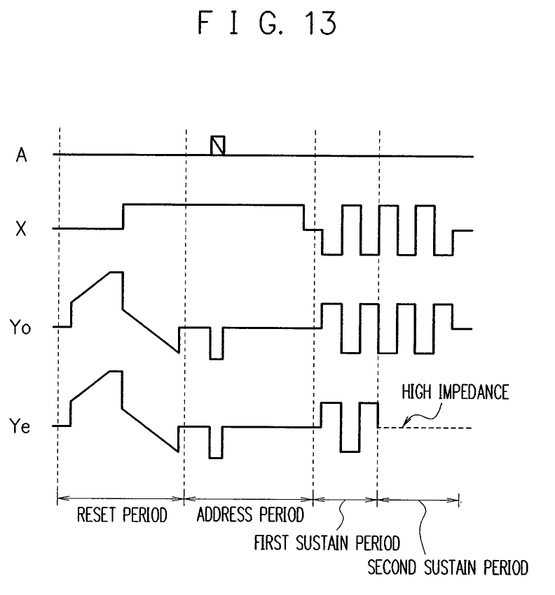

FIG. 13 is a chart illustrating one example of driving waveforms of the plasma display device according to the present embodiment. FIG. 13 illustrates one example of the driving waveforms related to the X electrode Xi, the Y electrode Yi and the address electrode Aj in one sub-frame out of a plurality of sub-frames constituting an odd frame. In FIG. 13, there are illustrated a voltage waveform A which is applied to the address electrode Aj, a voltage waveform X which is applied to the X electrode Xi, a voltage waveform Yo which is applied to the Y electrode Yi on the odd display line and a voltage waveform Ye which is applied to the Y electrode Yi on the even display line.

In the reset period, the cells Cij are initialized. In the reset period, positive-polarity dull waveforms are simultaneously applied to the Y electrodes Yi (Yo and Ye) to form wall charge and then negative-polarity dull waveforms are simultaneously applied thereto to adjust the amount of the wall charge on the cells Cij.

In the address period, scanning pulses are sequentially applied to the Y electrodes Yi and address pulses are applied to the address electrodes Aj correspondently with the scanning pulses and according to data (or an address is specified) to perform a scanning operation for selecting light emission or non light emission of each of the cells Cij. In the address period in the present embodiment, and for the odd frame, the (2n+1)th line being the odd display lines and the (2n+2)th line being the even display lines are simultaneously scanned to write the same data in corresponding cells. For the even frame, the (2n+2)th line being the even display lines and the (2n+3)th line being the odd display lines are simultaneously scanned to write the same data in corresponding cells.

In other words, in the present embodiment, scanning is performed with adjacent odd and even display lines paired together and the same data is written in the corresponding cells on the two lines. For example, in the odd frame, the data written in the cell C11 illustrated in FIG. 10 is written also in the cell C21. The data written in the cell C31 is written also in the cell C41. Similarly to the above, in the even frame, the data written in the cell C21 illustrated in FIG. 10 is written also in the cell C31. The data written in the cell C41 is written also in the cell C51. Incidentally, in the odd frame, the (2n+1)th line and the (2n)th line may be simultaneously scanned. In the even frame, the (2n+2)th line and the (2n+1)th line may be simultaneously scanned.

In a first sustain period, sustain pluses which are opposite in phase to each other are applied to the X electrode Xi and the Y electrode Yi (Yo and Ye) to perform sustain discharge between the X electrode Xi and the Y electrode Yi (Yo and Ye) of the cells selected in the address period to emit light. In the first sustain period, the sustain pulses applied to the Y electrodes Yo and Ye are the same in phase.

In a second sustain period, sustain pluses which are opposite in phase to each other are applied to the X electrode Xi and the Y electrode Yi (Yo) on the odd display lines to perform sustain discharge between the X electrode Xi and the Y electrode Yi (Yo) of the cells selected in the address period to emit light. On the other hand, as illustrated in FIG. 13, in the second sustain period of the odd frame, the switch SW1 connecting the scanning circuit (even) 21 to the sustain circuit 23 is turned off to render the Y electrode Yi (Ye) on the even display lines a high impedance.

Similarly to the above, in sub-frames constituting the even frame, in the second sustain period of the even frame, the switch SW2 connecting the scanning circuit (odd) 22 to the sustain circuit 23 is turned off to render the Y electrode Yi (Yo) on the odd display lines a high impedance.

According to the present embodiment, in the first sustain period, both the switches SW1 and SW2 are turned on, a pair of two lines is caused to simultaneously display images. If the pair of two lines is regarded as one line, position is displaced on display lines between the odd and even frames. Accordingly, in the first sustain period, an interlace drive is realized in the display of two lines.

In the second sustain period of the odd frame, the switch SW1 is turned off, and in the second sustain period of the even frame, the switch SW2 is turned off. Thus, in the second sustain period of the odd frame, the Y electrode Yi (Ye) on the even display lines is rendered a high impedance to inhibit the even display lines from discharging. In the second sustain period of the even frame, the Y electrode Yi (Yo) on the odd display lines is rendered a high impedance to inhibit the odd display lines from discharging. Accordingly, in the second sustain period, an interlace drive can be realized in the display of one line.

In the first and second sustain periods, a voltage waveform which the sustain circuit 23 in the Y electrode driver 20 applies to the Y electrode Yi (Ye and Yo) and a voltage waveform which the sustain circuit 31 in the X electrode driver 30 applies to the X electrode Xi are one kind of waveform, respectively. For this reason, one-phase sustain circuits 23 and 31 may be provided in the Y and the X electrode drivers 20 and 30 respectively, which can realize an interlace drive with a simple circuit configuration.

As described above, in the present embodiment, display is performed on two lines in the first sustain period and the interlace drive is performed in the second sustain period. Thereby, the sustain pulses with the number of sustain pulses “m” on the odd line OL in FIG. 5 can be applied to the Y electrode Yo on the odd display lines and the sustain pulses with the number of sustain pulses “n” on the even line EL in FIG. 5 can be applied to the Y electrode Ye on the even display lines.

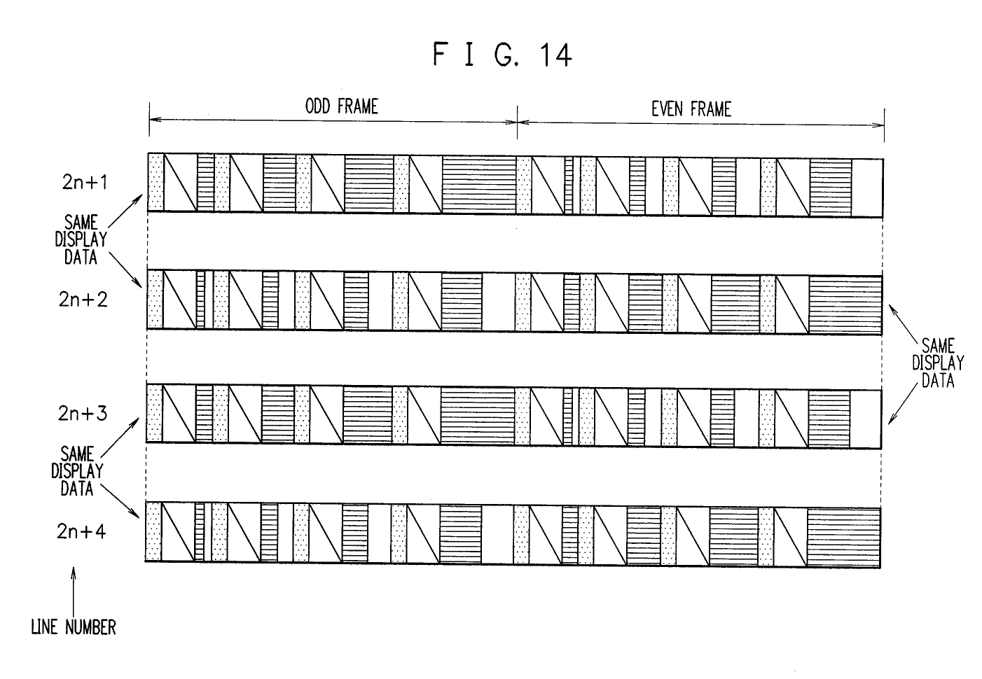

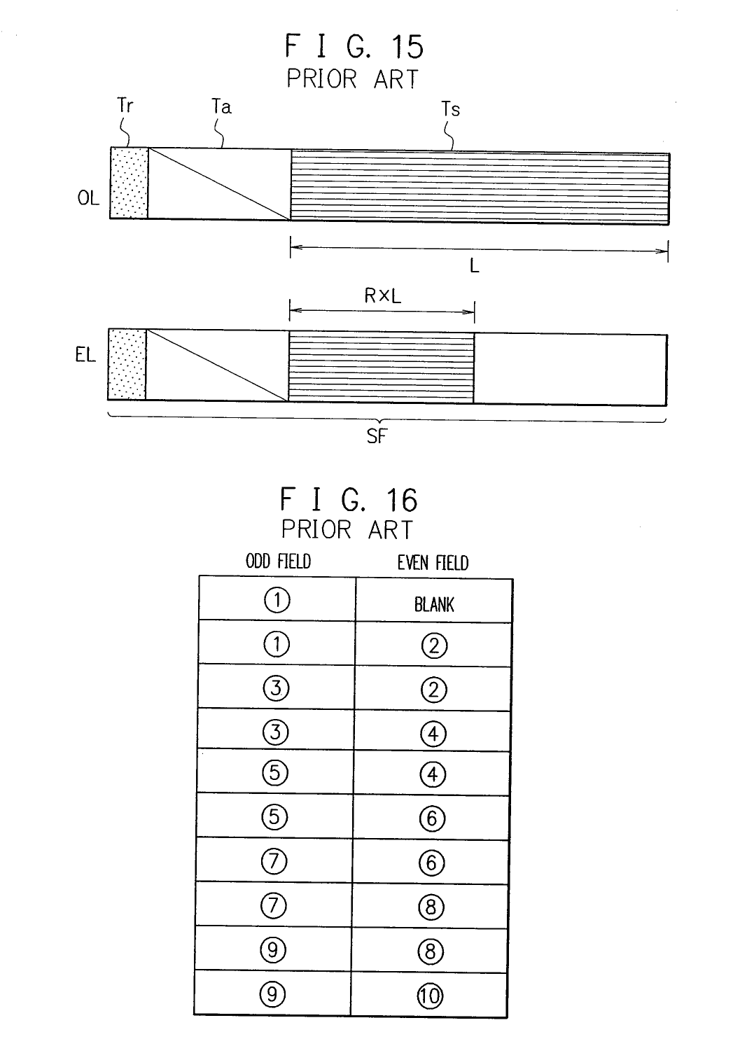

FIG. 14 illustrates a driving configuration according to the present embodiment. Out of two lines paired with each other, the number of sustain pulses on the one line can be taken as “m” and the number of sustain pulses on the other line can be taken as “n.” In the odd frame, writing is performed in the address period Ta based on the same data (image signal) with the (2n+1)th line paired with the (2n+2)th line, and writing is performed in the address period Ta based on the same display data (image signal) with the (2n+3)th line paired with the (2n+4)th line. In the even frame, writing is performed in the address period Ta based on the same display data (image signal) with the (2n+2)th line paired with the (2n+3)th line. Lines paired with each other are made different between the odd and even frames to enable the vertical resolution to be increased.

Thus, in the present embodiment, both in the odd and even frames, the same display data is written with two adjacent upper and lower lines paired. If the panel 10, in which each light-emission-intensity ratio is taken to be any of zero to one at the time of lighting, detects motion in an input image, the panel 10 renders the light-emission-intensity ratio a value more than zero to reduce the sustain period Ts, improving the moving picture pseudo contour and blurring of a moving picture.

The plasma display device in the present embodiment includes the plasma display panel 10 in which one display line is formed of a display electrode pair composed of two display electrodes (the X and Y electrodes) and the display electrode pair on the even display line EL and the display electrode pair on the odd display line OL are alternately arranged, the driving circuits 20 and 30 supplying voltage to the display electrodes to perform display based on the same display data with one even display line EL and one odd display line OL adjacent up and down paired in the plasma display panel 10, the motion detecting circuit 140 detecting motion in an image based on the image signal A2 and ratio determining circuits (the light-emission-intensity ratio calculating process circuit and the sustain number distribution circuit) 160 and 170 determining the ratio of the number of sustain pulses on the even display line EL to the number of sustain pulses on the odd display line OL which form the pair. The driving circuits 20 and 30 supply the display electrodes with sustain pulses equal in number to the sustain pulses the ratio in number between which is determined.

As illustrated in FIG. 14, the pair formed of the one even display line EL and the one odd display line OL is different between the odd and even frames.

The ratio determining circuits 160 and 170 determine the ratio so that the difference in the number of sustain pulses between the even display line EL and the odd display line OL forming the pair becomes smaller in the moving picture than in the still picture. That is to say, the ratio determining circuits determine the ratio so that the light-emission luminance ratio in FIG. 9 becomes larger.

As illustrated in FIG. 7, the ratio determining circuits 160 and 170 determine the ratio so that the difference in the number of sustain pulses between the even display line EL and the odd display line OL forming the pair becomes smaller as motion in the image becomes faster. That is to say, the ratio determining circuits determine the ratio so that the light-emission luminance ratio in FIG. 9 becomes larger.

As illustrated in FIG. 8, the ratio determining circuits 160 and 170 determine the ratio so that the difference in the number of sustain pulses between the even display line EL and the odd display line OL forming the pair becomes smaller as the number of pixels moved in the image becomes larger. That is to say, the ratio determining circuits determine the ratio so that the light-emission luminance ratio in FIG. 9 becomes larger.

As illustrated in FIGS. 4 and 5, the total number of sustain pulses on the even display line EL and the odd display line OL forming the pair is substantially the same irrespective of the ratio between the number of sustain pulses as long as the display data is the same. For example, the total number of sustain pulses is m+n, i.e., the same.

As illustrated in FIG. 6, one frame has a plurality of weighted sub-frames SF1 to SF5. The fewer the number of sustain pulses, the shorter the plurality of weighted sub-frames SF1 to SF5. The plurality of weighted sub-frames SF1 to SF5 is closed up forward.

As illustrated in FIG. 4, for the still picture, the ratio determining circuits 160 and 170 determine the ratio so that the number of sustain pulses of any one of the even display line EL and the odd display line OL forming the pair becomes zero.

As illustrated in FIG. 13, the driving circuits 20 and 30 select the display cells Cij on the same column on the even display line EL and the odd display line OL forming the pair in the address period Ta selecting the display cells Cij to be lit among the plurality of the display cells Cij forming the display lines. For example, scanning pulses are simultaneously applied to the Y electrodes Yo and Ye on the odd display lines formed of the odd-numbered Y electrode Yo and X electrode Xo and the even display lines formed of the even-numbered Y electrode Ye and X electrode Xe to select the display cells Cij on the same column.

The ratio between the number of sustain pulses is determined according to motion in an image to enable preventing the moving picture pseudo contour and blurring of a moving picture from being produced.

The present embodiment merely exemplifies concrete examples for carrying out the present invention, so that the technical scope of the present invention is not to be construed as being restricted by the examples. In other words, the present invention can be implemented in various forms without deviating from the technical concept and the main features thereof.

What is claimed is:

1. A plasma display device comprising:
a plasma display panel in which one display line is formed of a display electrode pair composed of two display electrodes and the display electrode pair on the even display line and the display electrode pair on the odd display line are alternately arranged;
driving circuits supplying voltage to the display electrodes to perform display based on the same display data with one even display line and one odd display line adjacent up and down paired in the plasma display panel;
a motion detecting circuit detecting motion in an image based on the image signal; and
ratio determining circuits determining the ratio of the number of sustain pulses on the even display line to the number of sustain pulses on the odd display line forming the pair; wherein
the driving circuits supply the display electrodes with sustain pulses equal in number to the sustain pulses the ratio in number between which is determined.

2. The plasma display device according to claim 1, wherein
the pair formed of the one even display line and the one odd display line is different between an odd frame and an even frame.

3. The plasma display device according to claim 1, wherein
the ratio determining circuits determine the ratio so that the difference in the number of sustain pulses between the even display line and the odd display line forming the pair becomes smaller in a moving picture than in a still picture.

4. The plasma display device according to claim 1, wherein
the ratio determining circuits determine the ratio so that the difference in the number of sustain pulses between the even display line and the odd display line forming the pair becomes smaller as motion in the image becomes faster.

5. The plasma display device according to claim 1, wherein
the ratio determining circuits determine the ratio so that the difference in the number of sustain pulses between the even display line and the odd display line forming the pair becomes smaller as the number of pixels moved in the image becomes larger.

6. The plasma display device according to claim 1, wherein
the total number of sustain pulses on the even display line and the odd display line forming the pair is substantially the same irrespective of the ratio between the number of sustain pulses as long as the display data is the same.

7. The plasma display device according to claim 1, wherein
one frame has a plurality of weighted sub-frames,
the fewer the number of sustain pulses, the shorter the plurality of weighted sub-frames, and
the plurality of weighted sub-frames is closed up forward.

8. The plasma display device according to claim 1, wherein
the ratio determining circuits, in the case of a still picture, determine the ratio so that the number of sustain pulses of any one of the even display line and the odd display line forming the pair becomes zero.

9. The plasma display device according to claim 1, wherein
the driving circuits select the display cells on the same column on the even display line and the odd display line forming the pair in the address period selecting the display cells to be lit among the plurality of the display cells forming the display lines.
